(19) United States
(12) Patent Application Publication
(10) Pub. No.: US 2010/0076877 A1
(43) Pub. Date: Mar. 25, 2010

(54) CREATING REVENUE SOURCES USING PAYROLL PROCESSING

(76) Inventors: Michael George Lenahan, Moraga, CA (US); Christen Ann Lenahan, Moraga, CA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 12/564,882

(22) Filed: Sep. 22, 2009

Related U.S. Application Data
(60) Provisional application No. 61/099,192, filed on Sep. 22, 2008.

(51) Int. Cl. G06Q 40/00; G06K 19/00; G06Q 10/00; G06Q 20/00

(52) U.S. Cl. 705/32; 235/487

(57) ABSTRACT

Example methods, apparatuses, and articles of manufacture are disclosed that may be used to provide or otherwise support creating new and/or reoccurring revenue sources using novel payroll processing techniques.

### CROSS-REFERENCE TO RELATED APPLICATION

The present application claims priority to provisional patent application Ser. No. 61/099,192 titled METHODS, APPARATUSES, AND/OR SYSTEMS ASSOCIATED WITH GIFT CARD FULFILLMENT THROUGH DEDUCTIONS, filed on Sep. 22, 2008.

### BACKGROUND

1. Field:

The present disclosure relates generally to electronic payment transactions and, more particularly, to revenue-generating techniques incorporating electronic payroll processing.

2. Information:

Each year brand companies invest significant marketing dollars to build brand awareness and customer loyalty. The business world recognized that the success of many retail companies revolves around repeat daily, weekly, or monthly purchases by customers that continue to seek out their favorite brands. While these customer relationships are core to their brand companies, it may be difficult to increase wallet-share of the existing customers, and to definitively forecast customers' repeat monthly spend. Typically, a wallet-share may refer to the amount of customers' total spending that brand companies are capturing in the particular categories of goods or services that they offer.

In today's competitive marketplace, simply having a strong brand or competing on price alone may be insufficient to boost long-term revenues or even prevent profit erosion. Customers expect to receive greater value for their loyalty, and to satisfy them brand companies may offer innovative experiences, customized solutions, and a convenience in a variety of situations. Today, customers are attracted to goods or services that are tailored specifically for their individual interests and spending patterns. In addition, modern-day “time famine” resulting from busy careers, family demands, and social obligations may make saving time and minimizing effort in overall shopping experience as important to customers as a good product or a low price.

To meet the demands of a progressively impatient and cost-conscious customer base, brand companies increasingly employ marketing tools, such as, for example, stored value or gift card programs, across many market segments. Gift cards may increase brand recognition by placing a particular brand and its marketing message right into a customer's wallet, for example. Besides raising awareness of brands and their product lines, a prepaid gift card may serve as an alternative payment solution for a customer or a gift recipient. In such a situation, a customer who has a branded gift card may patronize a brand company's business first and may, thus, increase its incremental sales through customer visits. In addition, the nature of a gift card makes it suitable for marketing and promotions since both the customer who purchases a gift card and the customer who receives the gift card may associate such an event with positive experiences of giving and receiving a gift in connection with a particular brand. In addition, gift card customers often tend to spend more on their favorite brands than actual denominated value stored on their gift cards.

Despite numerous benefits associated with branded gift card programs, there may be a disconnect between brand companies and their customer base. Such a disconnect, for example, may be attributed in part to the lack of unified infrastructure integrating numerous brand companies' business operations with the gift card business model. For example, customers may not be aware of specific promotional discounts that brand companies offer, may have difficulties locating a particular branded gift card, may not resort to gift cards except for top occasions, may be unwilling to spend time driving to a particular retailer to purchase a branded gift card just to save on fees, and so forth. As a result, gift cards are typically purchased on average only twice a year with a stored value of about fifty dollars per card. As such, it may be difficult for brand companies to capture larger customer wallet-share, increase repeat business, strengthen customer loyalty, and/or elevate the strength and value of their brands. Accordingly, it may be advantageous to connect brand companies with a customer base using evolving technology and processes, and adapting innovative business-building infrastructure while offering customers their favorite brands at a discount.

### BRIEF DESCRIPTION OF THE DRAWINGS

Non-limiting and non-exhaustive embodiments will be described with reference to the following figures, wherein like reference numerals refer to like parts throughout the various figures unless otherwise specified.

FIG. 1 is a flow diagram illustrating an implementation of a process for creating new and/or reoccurring revenue sources using payroll processing.

FIGS. 2 and 3 are illustrative representations of screenshot views of implementations of an employee display.

FIG. 4 is a flow diagram illustrating an implementation of a process for creating revenue sources.

FIG. 5 is a flow diagram illustrating particular features of the implementation of the process of FIG. 1.

FIG. 6 is a schematic diagram illustrating an implementation of a computing environment associated with one or more special purpose computing apparatuses supportive of the process of FIG. 1.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some examples of methods, apparatuses, and articles of manufacture are disclosed herein that may be used to create new and/or reoccurring revenue sources through one or more existing programs and/or processes, such as, for example, a branded stored value or gift card program and/or a payroll processing, so as to more definitively forecast customers' repeat spending behavior and/or capture more wallet-share than branded gift card programs alone. Before describing some examples of methods, apparatuses, and articles of manufacture in greater detail, the sections below will first introduce certain aspects of business-related programs and/or processes, which may be utilized to create new and/or reoccurring revenue sources. It should be appreciated, however, that techniques provided herein and claimed subject matter are not limited to these example implementations. For example, techniques provided herein may be adapted for use in a variety of business-building systems and/or data processing services, such as, e.g., banking and/or financial institution management, business process outsourcing, etc. In addition, any implementations or configurations described herein as “examples” are described herein for purposes of illustrations and are not to be construed as preferred or desired over other implementations or configurations.

As previously mentioned, branded gift card programs may be implemented by brand companies or other companies, for example, associated, directly or indirectly, with gift cards programs as a promotional and/or marketing tool to build the strength and value of their brands, increase customer loyalty, lower costs, and/or improve profitability, for example. Typically, although not necessarily, a customer may purchase a pre-paid card, branded or otherwise, either for personal use or as a gift for someone else (e.g., a gift card) at a specific brand company or other retailer, such as, for example, a department store or a supermarket, or a group of retailers, such as a shopping mall. As used herein, “retailer” or “brand company” may be used interchangeably and may refer to a person and/or publicly as well as non-publicly traded business entities that may provide goods and/or services on-line and/or in-store (e.g., retail store, business agency, grocery outlet, stand-alone kiosk, etc.). A gift card comprises a prepaid transaction card that may be identified by a specific number and may include a barcode or magnetic stripe on the back of the card. The amount purchased may be recorded as “stored value” or “face value” on the card and/or in the retailer's database, as will be described in greater detail below. To facilitate a purchase, the retailer may access the database, for example, by swiping the card along its magnetic stripe and may deduct the amount of the purchase from the card. After the card's stored or face value is redeemed, some retailers may allow for card reloading to periodically update it with value.

As will be described in greater detail below, in some implementations, gift card programs may be integrated with particular technology and/or processes, such as, for example, payroll processing, to create new and/or reoccurring revenue sources. In this particular context, integration may refer to communication or coordination between two or more application-specific programs and/or processes using a host application of one overall system or entity, such as, for example, a pre-spending benefit entity, as will be seen. As used herein, “payroll processing” may refer to a process or system of administration, management, and/or record-keeping of financial and other information of one or more employees relating, at least in part, to one or more employees' salaries, wages, bonuses, net pay, withholdings, and/or deductions that one or more employers may collect and use to calculate gross wages, subtract all pertinent withholdings and deductions, print checks, make direct deposits, and/or prepare all employment-related tax filings for such one or more employees. Typically, although not necessarily, withholdings and deductions may include, for example, federal, state, and/or local income taxes; Social Security and Medicare taxes; vacation and/or sick days; insurance premiums and/or retirement fund contributions, and so forth. Under some circumstances, an employer may outsource its payroll processing by engaging an outside payroll processing service or entity. In such a situation, one or more employers may communicate with such a payroll processing entity and may provide it with current payroll information, such as, for example, wages, hours, withholdings, deductions, etc., for an upcoming pay period. A payroll processing entity may charge such an employer a processing fee per pay period or on a periodic basis for payroll processing services, for example.

As will be seen, in some implementations, brand companies' commercial wallet-share may be increased through use of payroll processing implemented or otherwise supported by a pre-spending benefit entity. More specifically, as illustrated in the example implementations of the present disclosure, a pre-spending benefit entity may facilitate a transfer of funds on to a stored value or branded gift card using payroll technology and/or processes. For example, one or more employees may communicate to a pre-spending benefit entity their desire to participate in transferring a certain amount of their payroll funds (e.g., as monthly contributions) from after-tax payments (e.g., paycheck(s), direct deposit(s), etc.) to one or more brand companies in exchange for a discount. Such communications may be made via any suitable communication mechanisms, such as, for example, the public networks (e.g., the Internet, the World Wide Web, a telephone network), private networks (e.g., intranets), point-of-interaction devices (e.g., notepads, personal digital assistants, cellular phones, point-of-sale devices, in-store or stand-alone kiosks, etc.), wireless networks, local area networks (LAN), wide area networks (WAN), on-line and off-line communications, or the like.

In connection with processing the payroll, one or more employers of such one or more employees may deduct a defined amount and may transfer funds to a pre-spending benefit entity, which, in turn, may process the amount and forward the balance of funds (e.g., less processing fees, technology licensing fees, royalty fees, etc.) to one or more employee or customer-designated brand companies or retailers. Once brand companies receive such funds, the companies may instruct a pre-spending benefit entity to send one or more branded gift or stored value cards via mail and/or electronically to one or more participating employees, as will be seen. As used herein, “stored value” may refer to increased promotional retail value that may be calculated, at least in part, as the amount received by the brand companies from one or more participating employees, plus a promotional percentage brand companies may offer (e.g., a discount) that may be based, at least in part, on an amount and/or nature of an employee's contribution. Employees may subsequently redeem received branded gift cards at participating retailers (e.g., in-store and/or on-line). It should be appreciated that one or more functions and/or processes associated with a pre-spending benefit entity may be performed, partially or substantially, by one or more employers without outsourcing such functions and/or processes to a pre-spending benefit or other entity, including, for example, a payroll processing entity. In such a case, for example, one or more employers may integrate or otherwise adapt their business operations so as to realize the benefits of claimed subject matter in an embodiment or implementation that does not employ the use of a separate entity, as such. It is intended that claimed subject matter include any and all such embodiments, including those that use no separate entity, those that employ a payroll processing or other similar entity, as well as those that employ a pre-spending benefit entity.

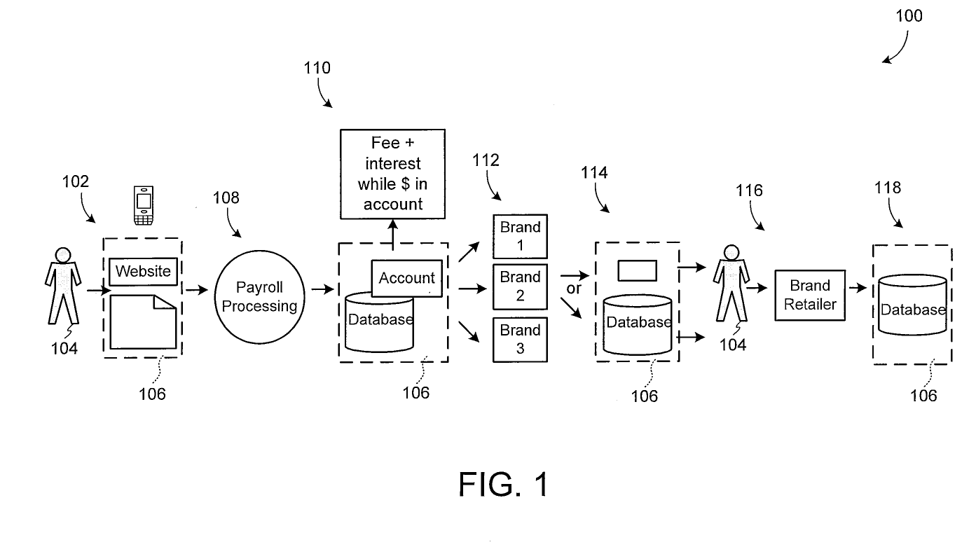

With this in mind, attention is drawn to FIG. 1, which is a flow diagram illustrating a summary of an example process 100 for creating new and/or reoccurring revenue sources using payroll processing. At operation 102, the process may begin with a customer or employee 104 electing to enroll or otherwise participate by defining a payroll contribution in a variety of forms associated with or otherwise provided by a pre-spending benefit entity, indicated generally in dashed lines at 106. As used herein, “customer,” “employee,” “consumer,” and/or the plural form of such terms may be used interchangeably and may refer to an individual person or persons, or entities that may be capable of participating in methods or systems disclosed in the present application, and/or may commercially benefit, directly or indirectly, from such participation. As a way of illustration, employee 104 may utilize a hard copy form or may choose to enroll on-line (e.g., using Internet-based solutions) or off-line (e.g., using intranet-based solutions), as will be seen. Initially, employee 102 may create a unique electronic employee profile via a client server process, for example, by entering basic identifying information, such as, employee name and address, employer name and identification number, and so forth, and may be prompted for a user ID and password selection. Optionally or alternatively, an employee may choose to participate on a limited or one-time basis only (e.g., for one payroll period, one month, etc.). In such a case, employee 104 may enter basic identifying information at the time the employee elects to participate in process 100. It should be appreciated that other forms of enrollment or participation may also be utilized, such as, for example, a telephone call (e.g., via a live operator or a voice-mail), e-mail, fax, and/or the like.

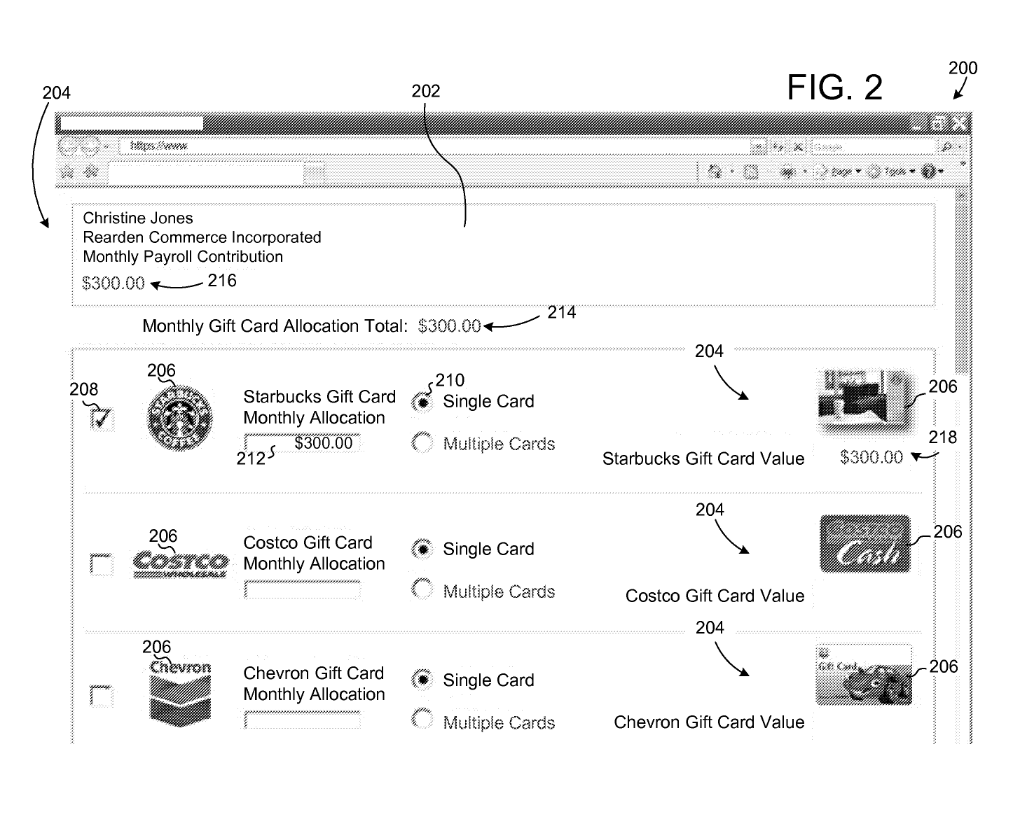

Turning now to FIG. 2, which is a representation of an embodiment of a screenshot view of an employee display 200 that may be used to facilitate process 100. As seen, an employee may access a website associated with a pre-spending benefit entity to view participating brand companies or retailers and to define a monthly payroll contribution, for example. It should be noted that any period of payroll contribution (e.g., weekly, bi-monthly, etc.) may be used to facilitate purposes of process 100. The website may be supported by any suitable browser technology for on-line access or off-line communications of the employee with a server associated with a pre-spending benefit entity, as will be described in greater detail below. Display 200 may be operated by a special purpose computing apparatus, such as, for example, a desktop computer, a notebook, a laptop computer, or other special purpose computing device or platform that may be enabled to communicate with the server (e.g., of pre-spending benefit entity) via an electronic network, such as, for example, LAN, WAN, the Internet, etc.

As illustrated, display 200 may comprise application window 202 as a graphical user interface (GUI) for a computing application or platform to manage and/or manipulate visual or other content, such as choosing a retailer, allocating a discount, defining an amount of contribution, etc., for example. As used herein, GUI may refer to a program interface that utilizes displayed graphical information to allow an employee to control or operate a special purpose computing platform by a pointer and/or a pointing device. A pointer may refer to a cursor, arrow, or other symbol that may appear on display 200 and may be moved or controlled with a pointing device to select or populate fields or input commands via a GUI of a special purpose computing platform. A pointing device may refer to any device used to control a cursor or arrow, to select objects, to populate fields, or to input information. Such pointing devices may include, for example, a mouse, a trackball, a track pad, a track stick, a keyboard, a stylus, a digitizing tablet, or similar types of devices. A cursor may refer to a symbol or a pointer where an input selection or actuation may be made with respect to a region in a GUI. Herein, terms such a “click” or “clicking” may refer to a selection process made by any pointing device, such as a mouse, for example, but use of such terms is not intended to be so limited. For example, a selection process may be made via a touch screen. In such a case, “clicking” may be replaced by “touching.” However, these are merely examples of methods of selecting objects or inputting information and claimed subject matter is not limited in scope in these respects.

Window 202 may include information fields, such as, for example, dynamic fields, indicated generally at 204 and user-selectable fields 208, 210, and 212 for facilitating one or more processes, as described in more detail previously. In some implementations, window 202 may be generated, at least in part, by a GUI and a special purpose computing platform associated with the employee, also referred to as “client,” as mentioned above. Such special purpose computing platform may transmit instructions or otherwise communicate a the pre-spending benefit entity server on a network, for example, to download payroll contribution information that may be stored with reference to a user ID or a unique profile associated with a particular employee or client. Subsequently, a special purpose network server (e.g., pre-spending benefit entity) may transmit information to a special purpose client computing platform (e.g., employee) to populate information fields 204 during log-in or a payroll allocation process. Such information may include employee name and address, employer name and ID number, participating brand companies or retailers and offered discounts, just to name a few examples. In this fashion, dynamic information fields may be populated as a result of access, for example. As seen, window 202 may also include dynamically populated branding fields 206, which may comprise one or more Joint Photographic Experts Group (JPEG) or other type of formatted files representing a logo, icon, branded gift card, or any combination thereof, with respect to participating retailers, such as, Starbucks, Costco, Chevron, etc., in the present example.

Continuing with FIG. 2, window 202 may include information fields 208, 210, and 212 that may be user-selectable to provide a variety of payroll contribution information or instructions, as mentioned above. For example, an employee may select a particular retailer by clicking on field 208 and checking a corresponding box using a mouse, or other pointing or selecting device. Similarly, an employee may choose a number of gift cards to be received from selected retailers by clicking on corresponding fields, such as, for example, field 210 for a single gift card. In addition, in field 212, an employee may define amount of funds to be deducted from after-tax payments (e.g., from paycheck, direct deposit, etc.) with respect to a selected retailer.

As seen, window 202 may also include a total amount of monthly gift card allocation, displayed in field 214, that may be auto-populated based, at least in part, on information previously entered by an employee in user-selectable fields. Similarly, a total of a monthly payroll contribution and a retailer's promotional gift card value may also be auto-populated and displayed in respective fields 216 and 218, as illustrated. Additional new retailers, amounts of payroll contribution, etc., may be designated by process repetition.

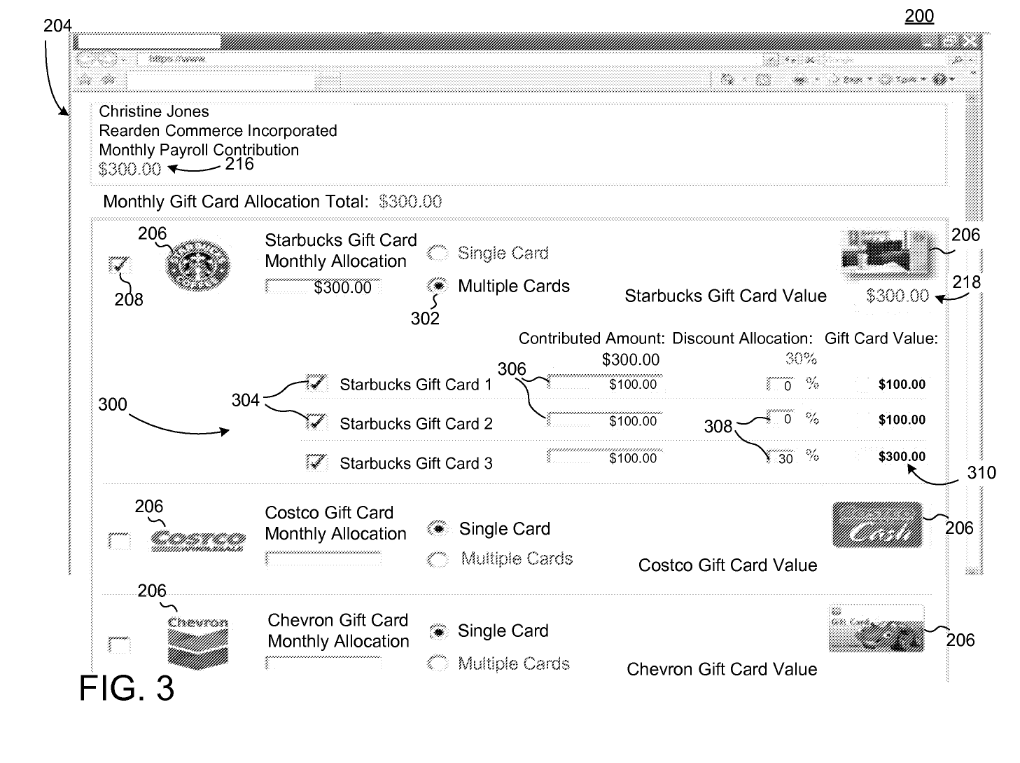

As seen in FIG. 3, application window 202 may comprise drop-down information sub-fields 300 resulting from a selection of a multiple gift cards option 302, for example. Accordingly, sub-fields 300 may prompt an employee to select a desired number of gift cards per a particular retailer (e.g., by checking boxes 304), and to define a contributed amount and a discount allocation for selected gift cards in fields 306 and 308, respectively. An employee may choose to distribute a discount equally between multiple gift or, as illustrated, may choose to allocate such a discount towards one card. For example, an employee may choose cards 1 and 2 as gifts for someone else and may keep card 3, with added promotional retail value, shown at field 310, for personal use. Of course, such details of the display are merely examples and claimed subject matter is not so limited.

As was indicated, in some implementations, client or employee 104 may elect to participate in process 100 using a variety of specific client devices, such as, for example, mobile phones, personal digital assistants, notepads, and the like, that may be enabled to communicate with a special purpose server computing platform associated with a pre-spending benefit entity. Such specific client devices may comprise one or more Central Processing Units, a memory, an input/output device (e.g., keypad, touch screen, etc.), a display, and an associated GUI to display visual content for review and input of information, as previously described with reference to FIGS. 2-3. It should be appreciated that such specific client devices may have a variety of different resident platforms and/or applications. In some implementations, such visual content may be rendered by an application, such as an information entry and processing application, which may reside on a specific device of a client or employee. Optionally or alternatively, such visual content may be rendered by a network browser residing on a specific client device that may receive information from a network server associated with a pre-spending benefit entity, for example. It should be noted that such visual content may or may not be encrypted.

In addition, a GUI may be enabled so as to allow an employee to participate in process 100 in response to an application that may reside on a specific client device and may or may not be associated with a pre-spending benefit entity. For example, as an employee makes purchases from various retailers, transactions may be stored in memory of a device (e.g., via scan-based and/or RFID-based solutions). Upon activation of an application by an employee, such information may be displayed in the form of an itemized purchase history, for example, and may include purchase dates, retailers, purchase amounts and types (in-store, on-line, etc.), just to name a few examples. Based, at least in part, on such history, an employee may be able to evaluate his or her purchasing patterns with respect to purchasing inventory and/or particular retailers. The employee, then, may be offered to participate in the payroll contribution process, for example, by touching or otherwise selecting a command to do so (e.g., via a key, button, icon, logo, etc.), and may be subsequently prompted to enter payroll contribution instructions, as discussed above. Accordingly, such an application may facilitate convenient collaboration among consumers and providers of goods or services by keeping consumers apprised of promotional and other marketing opportunities available in the marketplace.

It should be appreciated that employee 104 may elect to participate in process 100 via a stand-alone computing platform, such as, for example, a point-of-sale terminal or an outside kiosk, that may or may not be associated with a pre-spending benefit entity. Such kiosk may include a network browser or a similar application that may enable the kiosk to interact with a server (e.g., pre-spending benefit entity), located on a network, such as the Internet, intranets, and/or the like, as also described with reference to FIGS. 2-3. Of course, various embodiments of specific client devices and associated GUIs are possible, and the above examples are not intended to limit claimed subject matter to a particular embodiment.

After completion, employee instructions may be communicated to a pre-spending benefit entity server on a network, which may transmit instructions to one or more employers and/or entities administering or otherwise managing payroll processing for such an employee. It should be noted that such electronic content may be encrypted for security reasons. Such encryption may be applied to all or part of any electronic content and may include, for example, user ID and permission information (e.g., access passwords, etc.) and/or the like. Optionally or alternatively, such electronic content may be stored on a server associated with a pre-spending benefit entity on a network, which may be accessible via LAN, WAN, or the Internet to one or more employees. Of course, such details of process 100 are merely examples, and claimed subject matter is not so limited.

In some implementations, brand retailers may offer various discounts based, at least in part, on an amount of total payroll contribution, duration of employee's participation (e.g., single versus multi-month agreement), whether the contribution is allocated or unallocated, or any combination thereof. For example, after election to participate in a payroll contribution process, an employee may define a specific amount of contributions with or without allocation of funds with respect to particular retailers. If no allocation is made, unallocated funds may be transferred into an employee's account (e.g., hosted by a pre-spending benefit entity), upon which an employee may view and allocate funds at anytime by accessing a website, as illustrated in FIGS. 2-3. Without allocation of funds after enrollment (e.g., commitment from the employee), brand companies may be able to offer modest discounts to such an employee. The employee may also choose, after enrollment, to specifically allocate funds to a particular brand company in monthly or multi-monthly contributions, for example. In such a case, after funds have been transferred into an employee's account, such funds may be displayed on the website as a balance with a selected brand company along with a discount offered, as particularly seen in FIGS. 2-3. An employee's commitment to a particular brand company may result in greater retailer discounts than previously mentioned modest discounts. It should be noted that an employee may allocate funds to more than one retailer and/or may allocate a portion of contributed funds while leaving the remaining funds unallocated. It should be also appreciated that allocated funds may not be re-allocated or otherwise modified by an employee after instructions are entered or otherwise communicated to a pre-spending benefit entity, as will be described in greater detail below.

Referring back to FIG. 1, at operation 108 one or more employers may receive instructions with an employee's defined payroll contributions. As previously mentioned, such instructions may be communicated over a network from a special purpose server or computing platform maintained by or associated with a pre-spending benefit entity. During payroll processing, defined contributions may be deducted and deposited into an employee's account created by and/or associated with pre-spending benefit entity 106. With regard to operation 110, pre-spending benefit entity 106 may generate return on interest from deposited funds, for example, by transferring all or a portion of such funds to one or more banking and/or financial institutions for a holding period (e.g., one week), if implemented. A pre-spending benefit entity may also collect appropriate fees, such as, for example, a processing fee, a technology licensing fee, a royalty fee, and/or the like, and may subsequently transfer any balance of the allocated funds to designated brand companies. It should be appreciated that an outside payroll processing entity may be engaged to process payroll. In such a case, a pre-spending benefit entity may also collect a percentage of the payroll allocation fee that may be delivered by such payroll processing entity.

Further, at operation 112, one or more brand companies may receive transferred funds and may add a promotional percentage that they currently offer, thus, yielding increased promotional retail value for branded gift cards, as previously mentioned. As used herein, terms “card,” “pre-paid card,” “branded gift card,” “stored value card,” “omni-stored value card” are to be interpreted broadly and may refer to one or more transaction instruments in any stored value format (e.g., plastic card and/or coupon, electronic card and/or coupon, paper card, coupon, and/or certificate, etc.), that may be associated with corresponding transaction accounts of respective one or more employees and may have a cash equivalent value redeemable within a transaction infrastructure. It should be appreciated that such cards may or may not be reloadable with value. It should also be noted that such cards may include one or more types of electronic or electrical functionality (e.g., smart chip, digital paper, radio-frequency enabled, displayable barcode or number code, etc.), such as may be supported by one or more networks to further implement particular functions of these cards. In addition, transaction accounts may be implemented in physical embodiments (e.g., financial instruments, etc.) and/or non-physical embodiments (e.g., frequent flier miles account, cash back account, calling card account, etc.).

In an implementation, upon receipt of funds, one or more brand companies may instruct a pre-spending benefit entity to send one or more gift cards via mail and/or electronically to one or more employees or designated gift recipients, as indicated at operation 114. It should be appreciated that brand companies may send one or more gift cards to one or more employees or gift recipients directly in any suitable stored value format. As a way of illustration, brand companies and/or a pre-spending benefit entity may physically mail to such one or more employees or gift recipients one or more branded gift cards and/or coupons, redeemable in-store and/or on-line. In addition, so-called omni-stored value or gift cards may be designated and/or used by one or more employees or gift recipients. Omni-stored value cards may be issued by or otherwise directly associated with a pre-spending benefit entity and may represent a one-card proxy for multiple branded stored value or gift cards. For example, an omni-stored value card may consolidate multiple gift cards onto a single card that may be freely used at different participating retailers (e.g., on-line and/or in-store). It should be noted that an omni-stored value card may have an additional specified discount (e.g., a membership discount). Further, omni-stored value cards may pool and store different values reflective of multiple balances with multiple retailers within a card's general pool of stored face value. For example, an omni-stored value card may store $100 allocated to Starbucks, $50 to Costco, $50 to Chevron and, thus, may have a total stored face value of $200. It should be appreciated that retailers' stored values and/or balances may or may not be transferrable from one retailer to another within such omni-stored value card.

It should also be noted that, in some implementations, omni-stored value cards may pool and store a general unallocated value or balance that may be linked to an employee's or customer's pre-spend account associated with a pre-spending benefit or other entity (e.g., payroll processing entity, employer, etc.). In such a case, general pool of funds may represent stored or face value of such omni-stored value card that may be used, partially or substantially, at any participating retailer for a modest discount since no specific “pre-spend” allocation took place, as previously discussed (e.g., unallocated funds). For example, one or more employees and/or gift recipients may redeem such omni-stored value card at a participating retailer and funds may be debited to a pre-spend account of such one or more employees at time of purchase. In addition, a particular promotional discount may also be applied by a retailer at time of purchase.

In some implementations, one or more brand companies and/or a pre-spending benefit entity may send one or more branded gift cards or their stored value equivalents electronically to one or more employees and/or designated gift recipients. To illustrate, such equivalents may be in the form of an electronic coupon to be displayed on and read directly off the screen or display of a specific employee device (e.g., mobile phone, PDA, notebook, etc.), for example, via scan-based or RFID-based solutions; a printable electronic gift card or coupon redeemable on-line or in-store; and/or the like. Optionally or alternatively, the above gift cards or their stored value equivalents may be taken into a retail store to be scanned and exchanged for a physical branded gift card and/or omni-stored value card.

As mentioned above, as brand companies and/or a pre-spending benefit entity send gift cards to designated employee(s) and/or gift recipient(s), such information may be communicated, continually or from time to time, to a host server computer or computing platform associated with a pre-spending benefit entity, where such information may be maintained and may be accessible to one or more employees upon log-in (e.g., as an employee account information).

At operation 116, one or more employees and/or designated gift recipients may redeem received one or more branded gift cards and/or their stored value equivalents at participating retailers in a variety of forms, as mentioned above.

At operation 118, as one or more employees make their respective purchases at one or more participating retailers, information representative of such purchases may be communicated in real time or substantially concurrently to a server computer or computing platform associated with a pre-spending benefit entity, a payroll processing entity or other entity, including, for example, an employer in some embodiments, where respective employees' accounts may be updated with such information. After receipt of such information, a server may be enabled to communicate and/or download updated information onto a specific employee device for real-time display of respective updates that may reflect one or more employees' payroll contribution account(s). As used herein, “real time” may refer to amount of timeliness of data or information which has been delayed by an amount of time attributable to electronic communication and automatic data processing.

To reduce cards' value “breakage”, for example, the pre-spending benefit entity may facilitate a creation of tradable discounts (e.g., a secondary marketplace) that may or may not be hosted on an entity's server. In the context of the present disclosure, “breakage” may refer to branded gift cards or their stored value equivalents that are purchased or otherwise paid-for but are expired or never used. Accordingly, a secondary marketplace may represent a virtual or physical trading place where tradable discounts may be sold or otherwise traded at additional substantial discounts. As used herein, “tradable discounts” may generally refer to one of more branded gift cards and/or their stored value equivalents that are unwanted and/or partially or substantially unredeemed. Optionally or alternatively, brand companies may retain all or part of any residual values that may be left on cards, for example, as an incentive to participate in process 100.

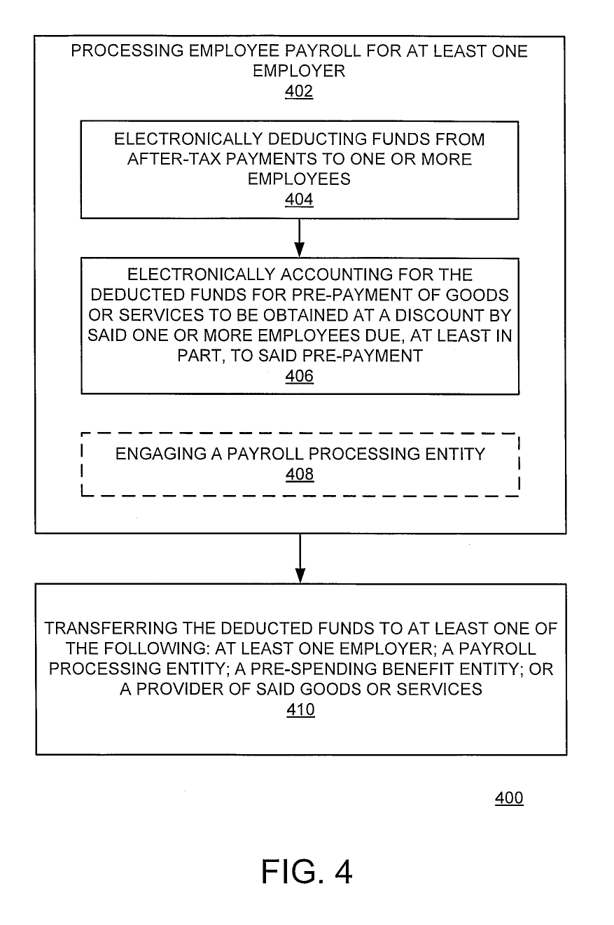

FIG. 4 is a flow diagram illustrating particular features 400 that may be present in an example process of creating new and/or reoccurring revenue sources using employee payroll. One or more employees with access to the Internet, for example, may elect to participate in a payroll contribution process. As such, one or more employees may provide to a pre-spending benefit entity personal information (e.g., for a unique employee profile) and instructions defining payroll contributions in the form of deductions, for example. An example process may proceed at operation 402 where processing employee payroll for at least one employer may be initiated. For example, such processing may comprise electronically deducting funds from after-tax payments (e.g., from paychecks, direct deposits, etc.) based, at least in part, on an employee's instructions, as indicated at operation 404. Next, at operation 406, payroll processing may further account for deducted funds that may be prepaid in exchange for a discount from participating providers of goods or services (e.g., brand companies, retailers, etc.) due to such prepayment. For example, such funds may include a specific amount to be allocated, an amount of such allocation, a discount distribution for selected retailers, just to name a few examples. Any balance of payroll funds may subsequently be forwarded to an employee as earnings for a particular pay period. At operation 408, an employer may engage or otherwise outsource payroll processing to an outside payroll processing service or entity. It should be noted that operation 408 may be optional in certain implementations. Finally, after completion of payroll processing, at operation 410, deducted funds may be transferred to an employee's account that may be created by or otherwise associated with a pre-spending benefit entity. Employees may view, for example, allocated funds and/or may allocate or otherwise manage unallocated funds within their respective accounts by logging-in onto a pre-spending benefit entity's website. Optionally or alternatively, deducted funds may be transferred directly to one or more participating providers of goods or services, at least one employer, and/or a payroll processing entity. In such a case, one or more employees may log-in onto the respective accounts to view and/or manage respective funds.

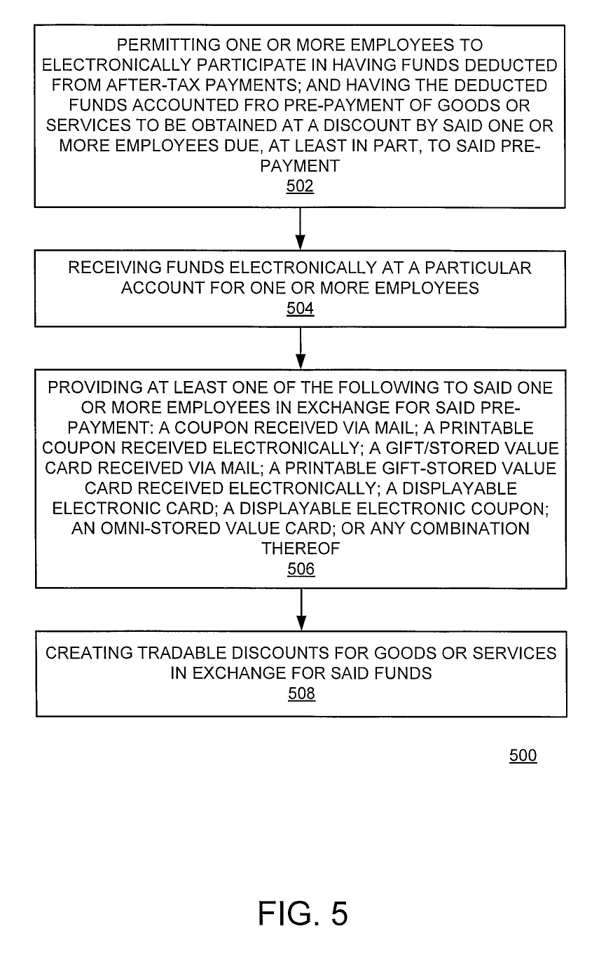

FIG. 5 is a flow diagram further illustrating particular features that may be present in the example process of FIG. 1. At operation 502, as previously described, based, at least in part, on communications received from one or more employees, a pre-spending benefit entity may allow such one or more employees to participate in process 100. For example, such participation may be rendered by an application, which may reside on an employee's specific device or by a network browser residing on an employee's special purpose computing platform that may receive enrollment-related information from a network server associated with a pre-spending benefit entity, for example. Next, at operation 504, a pre-spending benefit entity or a provider of goods or services, such as, for example, one or more brand companies, may receive funds defining payroll contributions for a participating employee. After funds have been received, at operation 506, a pre-spending benefit entity and/or brand companies may send to a designated employees and/or gift recipients one or more branded gift cards and/or their stored value equivalents where a specific discount has been applied to create a new promotional retail value (e.g., a printable coupon, a physical gift card, a displayable electronic card, etc.) via mail and/or electronically. Cards and/or their equivalents may be redeemed at participating retailers (e.g., in-store and/or on-line). At operation 508, a pre-spending benefit entity may create tradable discounts, such as, for example, a secondary marketplace of unwanted or unredeemed branded gift cards and/or their stored value equivalents, which may be sold or otherwise traded at additional substantial discounts to reduce “breakage,” as previously mentioned.

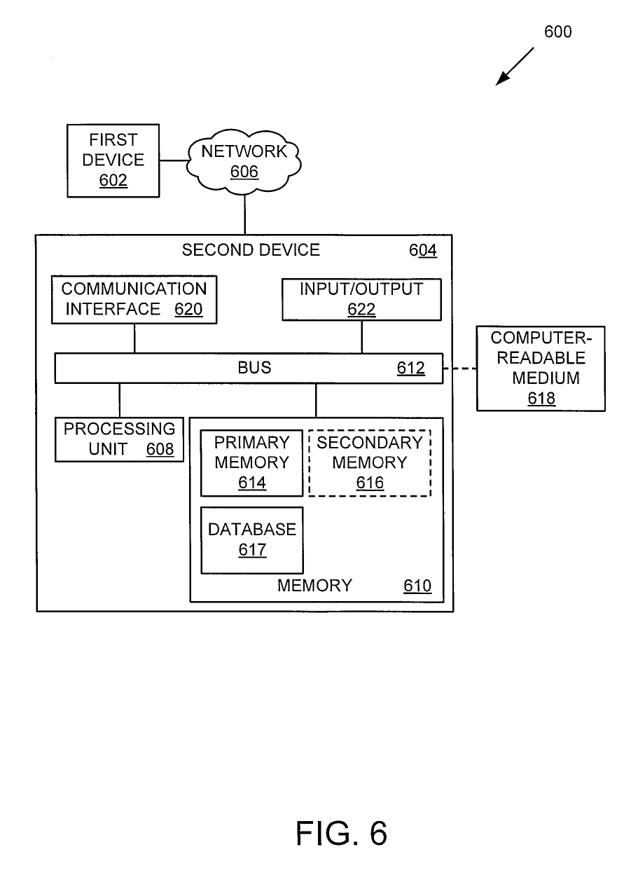

FIG. 6 is a schematic diagram illustrating an example computing environment 600 that may include one or more devices that may be configurable to partially or substantially implement a process for creating new and/or reoccurring revenue sources using one or more techniques described herein, such as, for example, payroll processing.

Computing environment system 600 may include, for example, a first device 602 and a second device 604, which may be operatively coupled together via a network 606. Although not shown, optionally or alternatively, there may be additional like devices operatively coupled to network 606

In an embodiment, first device 602 and second device 604 may be representative of any electronic device, appliance, or machine that may be configurable to exchange data over network 606. For example, first device 602 and second device 604 may include: one or more computing devices or platforms, such as, e.g., a desktop computer, a laptop computer, a workstation, a server device, data storage units, or the like.

Network 606 may represent one or more communication links, processes, and/or resources configurable to support exchange of data between first device 602 and second device 604. By way of example but not limitation, network 606 may include wireless and/or wired communication links, telephone or telecommunications systems, data buses or channels, optical fibers, terrestrial or satellite resources, local area networks, wide area networks, intranets, the Internet, routers or switches, and/or the like.

It should be appreciated that all or part of various devices and/or networks shown in computing environment system 600, and processes and/or methods as described herein, may be implemented using or otherwise include hardware, firmware, or any combination thereof along with software.

Thus, by way of example but not limitation, second device 604 may include at least one processing unit 608 that may be operatively coupled to a memory 610 through a bus 612. Processing unit 608 may represent one or more circuits to perform at least a portion of a data computing procedure or process. As a way of illustration, processing unit 608 may include one or more processors, controllers, microprocessors, microcontrollers, application specific integrated circuits, digital signal processors, programmable logic devices, field programmable gate arrays, and/or the like.

Memory 610 may represent any data storage mechanism. For example, memory 610 may include a primary memory 614, a secondary memory 616, and/or a database 617. Primary memory 614 may include, for example, a random access memory, read only memory, etc. While illustrated in this example as being separate from processing unit 608, it should be appreciated that all or part of primary memory 614 may be provided within or otherwise co-located/coupled with processing unit 608.

Secondary memory 616 may include, for example, the same or similar type of memory as primary memory and/or one or more data storage devices or systems, such as, for example, a disk drive, an optical disc drive, a tape drive, a solid state memory drive, etc. In certain implementations, secondary memory 616 may be operatively receptive of, or otherwise enabled to be coupled to, a computer-readable medium 618. Computer-readable medium 618 may include, for example, any medium that can store and/or provide access to data, code and/or instructions for one or more devices in system 600.

Database 617 may comprise any data storage mechanism and may be enabled to store or otherwise provide access to information in a variety of information processing environments partially or substantially associated with process 100 (e.g., employees account information, purchase history information, etc). While illustrated in this example as being separate from primary memory 614 and secondary memory 616, it should be appreciated that all or part of database 617 may be provided within or otherwise co-located/coupled with respective memories 614 and 616, or stored elsewhere in a memory in other embodiments.

Second device 604 may include, for example, a communication interface 620 that may provide for or otherwise support operative coupling of second device 604 to at least network 606. By way of example but not limitation, communication interface 620 may include a network interface device or card, a modem, a router, a switch, a transceiver, and/or the like.

Second device 604 may include, for example, an input/output device 622. Input/output device 622 may represent one or more devices or features that may be able to accept or otherwise input human and/or machine instructions, and/or one or more devices or features that may be able to deliver or otherwise output human and/or machine instructions. By way of example but not limitation, input/output device 622 may include a display, speaker, keyboard, mouse, trackball, touch screen, data port, and/or the like.

Thus, as illustrated in various example implementations and/or techniques presented herein, in accordance with certain aspects, a method may be provided for use as part of a special purpose computing device and/or other like machine that accesses digital signals from memory and processes such digital signals to establish transformed digital signals which may be stored in memory as part of one or more data files and/or a database specifying and/or otherwise associated with an index.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

According to an implementation, one or more portions of an apparatus, such as second device 604, for example, may store one or more binary digital electronic signals representative of information expressed as a particular state of a device, here, second device 604. For example, an electronic binary digital signal representative of information may be “stored” in a portion of memory 610 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, here, for example, memory device 610, to a different state or thing.

While certain example techniques have been described and shown herein using various methods and/or systems, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
processing employee payroll for at least one employer, said processing comprising:
electronically deducting funds from after-tax payments to one or more employees; and
electronically accounting for the deducted funds for pre-payment of goods or services to be obtained at a discount by said one or more employees due, at least in part, to said pre-payment.

2. The method of claim 1, and further comprising:
transferring the deducted funds to at least one of the following: at least one employer; a payroll processing entity; a pre-spending benefit entity; or a provider of said goods or services.

3. The method of claim 1, wherein said processing includes engaging a payroll processing entity.

4. The method of claim 1, wherein said electronically deducting funds is based, at least in part, in having the funds deducted from after-tax payments of said one or more employees' by indication to participate to at least one of the following: at least one employer; a payroll processing entity; a pre-spending benefit entity; or a provider of said goods or services.

5. A method comprising:
receiving funds electronically at a particular account for one or more employees;
said funds having been electronically deducted from after-tax payments to one or more employees and electronically received in exchange for pre-payment of goods or services to be obtained at a discount by said one or more employees due, at least in part, to said pre-payment.

6. The method of claim 5, wherein at least one of the following receives said funds: a pre-spending benefit entity; a provider of said goods or services; a payroll processing entity; or at least one employer.

7. The method of claim 5, and further comprising:
providing at least one of the following to said one or more employees in exchange for said pre-payment: a coupon received via mail; a printable coupon received electronically; a gift/stored value card received via mail; a printable gift/stored value card received electronically; a displayable electronic card; a displayable electronic coupon; an omni-stored value card; or any combination thereof.

8. An article comprising:
a storage medium having instructions stored thereon executable by a special purpose computing platform to process employee payroll for at least one employer; and further to electronically deduct funds from after-tax payments to one or more employees; and electronically account for the deducted funds for pre-payment of goods or services to be received at a discount by said one or more employees due, at least in part, to said pre-payment.

9. The article of claim 8, wherein said storage medium further includes instructions to permit said one or more employees to participate in having funds deducted from after-tax payments.

10. The article of claim 8, wherein said storage medium further includes instructions to transfer the deducted funds to at least one of the following: a pre-spending benefit entity; a provider of said goods or services; a payroll processing entity; or at least one employer.

11. An article comprising:
a storage medium having instructions stored thereon executable by a special purpose computing platform to receive funds electronically at a particular account for one or more employees;
said funds having been electronically deducted from after-tax payments to one or more employees and electronically received in exchange for pre-payment of goods or services to be obtained at a discount by said one or more employees due, at least in part, to said pre-payment.

12. The article of claim 11, wherein said storage medium further includes instructions to enable at least one of the following to receive said funds: a pre-spending benefit entity; a provider of said goods or services; a payroll processing entity; or at least one employer.

13. The article of claim 11, wherein said storage medium further includes instructions to create tradable discounts for goods or services in exchange for said funds.

14. The article of claim 11, wherein said storage medium further includes instructions to electronically receive updates relating to said funds from at least one of the following: a pre-spending benefit entity; a provider of said goods or services; a payroll processing entity; or at least one employer.

15. The article of claim 14, wherein said storage medium further includes instructions to include in said updates at least one of the following: an itemized purchase history of said one or more employees, said history being related to said provider of said goods or services; an amount of the deducted funds; a balance of funds available to said one or more employees after obtaining said goods or services by said one or more employees; or any combination thereof.

16. The article of claim 14, wherein said storage medium further includes instructions so that said updates are capable of being performed via real time communications.

17. An apparatus comprising:
a computing platform to process employee payroll for at least one employer, in which said computing platform is to electronically deduct funds from after-tax payments to one or more employees, and is to electronically account for the deducted funds for pre-payment of goods or services to be obtained at a discount by said one or more employees due, at least in part, to said pre-payment.

18. The apparatus of claim 17, wherein said computing platform further to transfer the deducted funds to at least one of the following: a pre-spending benefit entity; a provider of said goods or services; a payroll processing entity; or at least one employer.

19. An apparatus comprising:
a computing platform to receive funds electronically at a particular account for one or more employees;
said funds having been electronically deducted from after-tax payments to one or more employees and electronically received in exchange for pre-payment of goods or services to be obtained at a discount by said one or more employees due, at least in part, to said pre-payment.

20. The apparatus of claim 19, wherein at least one of the following receives said funds: a pre-spending benefit entity; a provider of said goods or services; a payroll processing entity; or at least one employer.

21. The apparatus of claim 19, wherein said computing platform is further enabled to create tradable discounts for goods or services in exchange for said funds.

22. A method comprising:
permitting one or more employees to electronically participate in:
having funds deducted from after-tax payments; and
having the deducted funds accounted for pre-payment of goods or services to be obtained at a discount by said one or more employees due, at least in part, to said pre-payment.

23. The method of claim 22, wherein said permitting one or more employees to electronically participate in having funds deducted from after-tax payments is capable of being performed by using a network browser of a specific device of said one or more employees.

24. The method of claim 23, wherein said network browser of said specific device to recognize an indication to participate in having funds deducted from after-tax payments for pre-payment of goods or services to be obtained at a discount by said one or more employees.

25. The method of claim 22, wherein the permission is based, at least in part, on real-time communications.

26. A method comprising:
creating tradable discounts for goods or services in exchange for funds having been electronically deducted from after-tax payments to one or more employees and electronically received in exchange for pre-payment of goods or services to be obtained at a discount by said one or more employees due, at least in part, to said pre-payment;
wherein said discount comprises at least one of the following: an unallocated discount; or an allocated discount.

27. The method of claim 26, wherein said allocated discount is greater than said unallocated discount.

28. The method of claim 26, wherein tradable discounts are traded through at least one of the following: a pre-spending benefit entity; or a provider of goods or services.
